(19) United States
(12) Patent Application Publication
(10) Pub. No.: US 2018/0326421 A1
(43) Pub. Date: Nov. 15, 2018

(54) INSECT TIPPING ASSEMBLY AND METHOD

(71) Applicants: Fernando Martínez Menéndez, München (DE); M. María Victoria Miguel Anaya, Alcalá de Henares (ES); M. Ivana Bjedov, Stratford Greater London (GB); M. Victoria Eugenia Martínez Miguel, London (GB)

(72) Inventors: Fernando Martínez Menéndez, München (DE); M. María Victoria Miguel Anaya, Alcalá de Henares (ES); M. Ivana Bjedov, Stratford Greater London (GB); M. Victoria Eugenia Martínez Miguel, London (GB)

(21) Appl. No.: 15/774,188

(22) PCT Filed: Nov. 9, 2016
(86) PCT No.: PCT/GB2016/053504

§ 371 Date: May 7, 2018

(30) Foreign Application Priority Data
Nov. 9, 2015 (EP) 15193761.2
Apr. 15, 2016 (GB) 1606656.5

(51) Int. Cl. B01L 3/00

(52) U.S. Cl. CPC B01L 3/563; B01L 9/06; B01L 2400/0633

(57) ABSTRACT

A tipping assembly for transferring insects from one or more first vials to one or more second vials, the tipping assembly comprising: a turnable attachment member comprising a first side to which the one or more first vials are selectively attachable and a second side to which the one or more second vials are selectively attachable; and a cover portion configured to be slidably received in a slot in the attachment member, wherein the attachment member defines one or more passages therethrough for the selective transfer of insects from the one or more first vials to the one or more second vials respectively when the cover portion is in a retracted position, and wherein the cover portion is configured to restrict the one or more passages through the attachment member when the cover portion is in an inserted position in the slot.

### TECHNICAL FIELD

The present disclosure relates generally to a tipping assembly for transferring insects from a first vial to a second vial, and particularly, although not exclusively, relates to a tipping assembly comprising an attachment member to which the vials may be attached, the attachment member comprising a selectively openable passage for the selective transfer of insects from the first vial to the second vial.

### BACKGROUND

Laboratory insects, in particular fruit flies, such as Drosophila melanogaster flies, are used for research. The flies used in laboratories are grown in plastic vials with fly food at the bottom. Once the food is depleted, the flies must be transferred to a new fresh vial. Transferring the flies to a new vial is called “tipping” or “flipping”.

Each vial must be individually tapped down to move the flies down to the bottom of the vial, far from a plug in the open end of the vial. The plug must then be removed and the insects carefully transferred to a new vial with fresh food. A plug is then inserted into the open end of the new vial. The plug may comprise a disposable porous material, such as cotton wool, to permit air to circulate.

This process typically occurs three times a week for each vial containing an insect and laboratories may have a large number of such vials. Only big laboratories can afford robotic machines that can perform this job. Therefore, in many laboratories this process is carried out by hand. As a result, scientists spend a lot of time transferring flies from one individual vial to another.

The manual nature of this process also risks insects escaping and potentially mixing up samples. Furthermore, the disposable plugs are wasted.

### STATEMENTS OF INVENTION

According to an aspect of the present disclosure, there is provided a tipping assembly for transferring insects from a first vial to a second vial, the tipping assembly comprising an attachment member to which the vials may be attached, the attachment member comprising a selectively openable passage for the selective transfer of insects from the first vial to the second vial.

According to an aspect of the present disclosure, there is provided a tipping assembly for transferring insects from one or more first vials to one or more second vials, the tipping assembly comprising:
a turnable, e.g. rotatable, attachment member comprising a first side to which the one or more first vials are selectively attachable and a second side to which the one or more second vials are selectively attachable; and
a cover portion configured to be slidably received in a slot in the attachment member,
wherein the attachment member defines one or more passages therethrough for the selective transfer of insects from the one or more first vials to the one or more second vials respectively when the cover portion is in a retracted position, and
wherein the cover portion is configured to restrict the one or more passages through the attachment member when the cover portion is in an inserted position in the slot.

The attachment member may comprises a first side wall, e.g. at the first side of the attachment member, and a second side wall, e.g. at the second side of the attachment member. The second side wall may be spaced apart from the first side wall so as to define the slot therebetween.

Each of the first and second side walls may comprise one or more openings. The or each opening in the first side wall may be opposite a corresponding opening in the second side wall. The or each passage may be at least partially defined by corresponding openings in the first and second side walls.

Each of the first and second sides may comprise one or more engaging portions. The engaging portions may be configured to selectively and sealingly engage an open end of the first or second vial. Each of the engaging portions may be associated with one of the openings in the first and second side walls. The engaging portions may be configured to selectively and sealingly engage the open end of the first or second vial around the associated opening.

The engaging portions may be configured to engage the first or second vial by virtue of a snap fit. For example, the vials may be pushed or slid into place. The engaging portions may comprise a narrowing, such as a throat or restriction, for the open end of the vial to pass through. The narrowing may be narrower than a standard vial diameter. The vial may pass through the narrowing by virtue of the vial and/or engaging portion resiliently deforming. The engaging portions may comprise a shoulder or taper configured to engage a rim about the open end of the first or second vial.

The cover portion may comprise one or more mesh sections. The one or more mesh sections may be configured to restrict the one or more passages through the attachment member when the cover portion is in the inserted position in the slot. For example, the mesh sections may be configured to permit the flow of air into the vial, but not permit the escape of the insects. Openings in the mesh section may be sized accordingly. The or each mesh section may be provided between corresponding openings in the first and second side walls when the cover portion is in the inserted position in the slot.

The tipping assembly may further comprise a transfer portion configured to be slidably received in the slot. The transfer portion may comprise one or more openings configured to permit the transfer of insects from the one or more first vials to the one or more second vials respectively when the transfer portion is in an inserted position in the slot. The or each transfer portion opening may be provided between the corresponding openings in the first and second side walls when the transfer portion is in the inserted position in the slot.

The attachment member slot may be configured to alternatingly, e.g. interchangeably, receive the cover portion and transfer portion. The cover portion and transfer portion may be separate components. Alternatively, the cover portion and transfer portion may be unitary, e.g. integral.

At least a lengthwise portion of the attachment member slot may have a width greater than a corresponding width of the cover portion and/or transfer portion. The slot may receive one of the cover portion and transfer portion and at least a portion of the other of the cover portion and transfer portion.

The attachment member and/or transfer portion may be configured such that the attachment member and transfer portion fit together with an interference fit. Likewise, the attachment member and/or cover portion may be configured such that the attachment member and cover portion fit together with an interference fit. Such interference fits may be provided by a projection at each end of the cover portion and/or transfer portion. The projections may hold the cover portion and/or transfer portion in place against corresponding ends of the slot.

The slot may extend from a first edge to a second edge of the attachment member such that the cover portion may be inserted into the slot at either the first edge or second edge. Accordingly, the transfer portion may be inserted into either the first edge or second edge, e.g. the edge opposite to which the cover portion has been inserted.

The attachment member may be manually rotatable, e.g. about a longitudinal axis of the attachment member. The attachment member may comprise finger or thumb holds at ends of the attachment member, e.g. to assist rotation of the attachment member.

The attachment member may comprise a plurality of passages therethrough. Accordingly, each of the first and second side walls may comprise a plurality of corresponding openings.

The attachment member may comprise one or more dividing walls. The or each dividing wall may be provided between neighbouring passages and extending across the slot between the first and second walls. The cover portion may comprise one or more slits configured to receive a corresponding dividing wall. The cover portion slits may be provided between neighbouring mesh sections. Likewise, the transfer portion may comprise one or more slits configured to receive a corresponding dividing wall. The transfer portion slits may be provided between neighbouring openings in the transfer portion. The cover portion and/or transfer portion slits may extend partially across a width of the cover portion and/or transfer portion.

The attachment member may be elongate and the slot may extend lengthwise between ends of the attachment member. The openings may be distributed along the length of the attachment member. The slot may be open along the length of the attachment member and the cover portion and/or transfer portion may be inserted into the slot in a width-wise direction of the attachment member/slot. Alternatively, the slot may be open at ends of the elongate member and the cover portion and/or transfer portion may be inserted into the slot in a lengthwise direction of the attachment member/slot.

The attachment member may comprise a row of passages. The attachment member may comprise a further row of passages arranged alongside, e.g. adjacent to, the row of passages. The passages in the row and further row of passages may be aligned, e.g. such that the attachment member may form a matrix of passages. Such an arrangement may permit more vials to be attached to the attachment member without necessarily increasing the length of the attachment member.

The cover portion may comprise a plurality of mesh sections arranged in a row. The cover portion may further comprise a plurality of openings configured to permit the transfer of insects from the first vials to the second vials respectively. The plurality of openings may be arranged in a row alongside the row of mesh sections. The individual openings in the row of openings may be aligned with individual mesh sections in the row of mesh sections.

The cover portion may comprise a further row of mesh sections. The further row of mesh sections may be arranged alongside the row of openings in the cover portion. The row of openings may be disposed between the row of mesh sections and the further row of mesh sections. The mesh sections in the further row of mesh sections may be aligned with respective openings in the row of openings.

The transfer portion may comprise a row of openings, The transfer portion may further comprise a plurality of mesh sections arranged in a row. The plurality of mesh sections may be arranged in a row alongside the row of openings. The individual openings in the row of openings may be aligned with individual mesh sections in the row of mesh sections.

The attachment member may comprise a tab at each end of the attachment member. The tab may be configured to be held in a groove in a supporting rack.

The tipping assembly may further comprise a rack for supporting ends of the attachment member. The rack may comprise a pair of rails configured to support the ends of the attachment member. Each rail may comprise a groove configured to receive a tab provided on each end of the attachment member so that the attachment member may be held in place as the rack is rotated.

The tipping assembly may further comprise one or more vials. The vials may be made from plastic. The vials may be transparent. The vials may have a standard outer diameter, such as 24 mm, 25 mm or 28.5 mm. Alternatively, the vials may have a non-standard outer diameter. The engaging portions may be configured to engage a vial with a particular outside diameter.

The above-mentioned tipping assembly may be used in performing a negative geotaxis (or gravitaxis or climbing) assay on the insects.

According to an aspect of the present disclosure, there is provided a method of transferring insects from one or more first vials to one or more second vials, the method comprising:
attaching one or more second vials to a second side of an attachment member to which one or more first vials are attached to a first side of the attachment member;
restricting one or more passages through the attachment member with a cover portion slidably received in a slot in the attachment member;
slidably retracting the cover portion from the slot in the attachment member;
turning the attachment member;
transferring insects from the one or more first vials to the one or more second vials respectively through the respective one or more passages in the attachment member; and
slidably inserting the cover portion into the slot in the attachment member to restrict the one or more passages through the attachment member.

The method may further comprise removing the first vials from the attachment member. The method may subsequently be repeated, e.g. to transfer insects from the second vials to further first vials on the first side of the attachment member. The method may further comprise inserting a transfer portion into the slot in place of the cover member. The method may further comprise exchanging the cover portion for another cover portion. The cover portions, e.g. mesh sections of the cover portion, may be cleaned.

The method may further comprise performing a negative geotaxis (or gravitaxis or climbing) assay on the insects in the one or more second vials.

According to another aspect of the present disclosure, there is provided a tipping assembly for transferring insects from a first vial to a second vial, the tipping assembly comprising:
an attachment member comprising a first side wall and a second side wall spaced apart from the first side wall so as to define a slot therebetween, each of the first and second side walls comprising one or more openings and one or more engaging portions associated with the or each opening, wherein the engaging portions are configured to selectively sealingly engage an open end of the first or second vial around the associated openings and the or each opening in the first side wall is opposite a corresponding opening in the second side wall; and
a cover portion configured to be slidably received in the slot, the cover portion comprising one or more mesh sections, the or each mesh section being provided between corresponding openings in the first and second side walls when the cover portion is in an inserted position in the slot;
wherein a passage for the transfer of insects from the first vial attachable to the first side wall, through the corresponding openings and to the second vial attachable to the second side wall is provided when the cover portion is in a retracted position.

To avoid unnecessary duplication of effort and repetition of text in the specification, certain features are described in relation to only one or several aspects or embodiments of the invention. However, it is to be understood that, where it is technically possible, features described in relation to any aspect or embodiment of the invention may also be used with any other aspect or embodiment of the invention.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 is a top view of the tipping assembly comprising an attachment member, cover portion and transfer portion according to an example of the present disclosure;

FIG. 2 is a side view of the attachment member according to an example of the present disclosure;

FIG. 3 is a top view of the tipping assembly showing the cover portion in an installed position in the attachment member;

FIG. 4 is top view of the tipping assembly showing the transfer portion in an installed position in the attachment member;

FIG. 5 is an exploded perspective view of the attachment member;

FIGS. 6a and 6b are enlarged partial top and side views respectively of the attachment member showing engaging portions according to an example of the present disclosure;

FIG. 7 is a perspective view of an engaging portion according to another example of the present disclosure;

FIGS. 8a and 8b show a rack for holding the tipping assembly, with FIGS. 9a and 9b showing the rack without and with the tipping assembly respectively;

FIGS. 9a-9f are perspective views showing a sequence in which insects are transferred from first vials to second vials;

FIG. 10 is a top view of an alternative tipping assembly showing the cover portion and transfer portion in a retracted position; and

FIG. 11 is a top view of a further alternative tipping assembly showing first and second cover portions in a retracted position.

### DETAILED DESCRIPTION

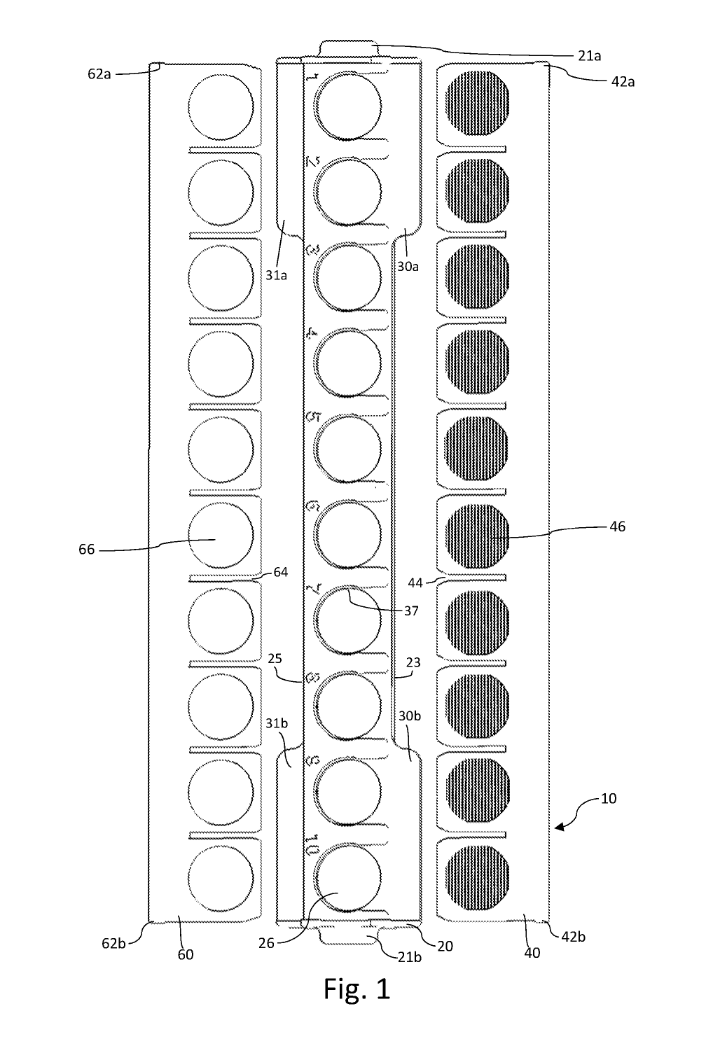

With reference to FIGS. 1 to 5, a tipping assembly 10 according to an arrangement of the present disclosure, comprises an attachment member 20 and a cover portion 40. The tipping assembly 10 may further comprise an optional transfer portion 60. The tipping assembly 10 is configured to transfer insects, in particular fruit flies, such as Drosophila melanogaster flies, from a first vial attached to a first side 22 of the attachment member to a second vial attached to a second side 24 of the attachment member. The insects are transferred from the first vial to the second vial by selectively moving the cover portion 40 to open a passage 26 through the attachment member. The attachment member 20 may then be rotated so that the insects are transferred from the first vial to the second vial by virtue of gravity. The passage 26 may be subsequently closed and the first vials may be removed.

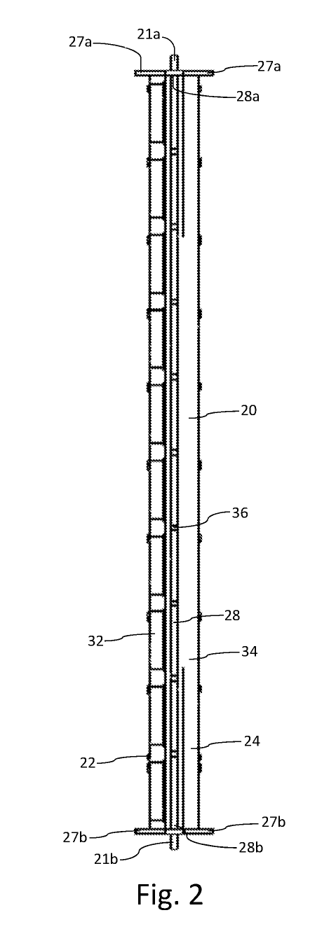

As shown in FIG. 2, the attachment member 20 comprises a slot 28, which is configured to receive the cover portion 40. The transfer portion 60 may also be received in the slot 28. The attachment member 20 may be elongate and the slot 28 may extend along the length of the attachment member 20. The slot 28 may extend from a first edge 23 of the attachment member to a second edge 25 of the attachment member such that the slot 28 extends all the way through the width of the attachment member 20 and is open at both the first and second edges 23, 25. Accordingly, the cover portion 40 may be inserted into the slot at either the first edge 23 or the second edge 25. Likewise, the transfer portion 60 may be inserted into the slot 28 at either of the first or second edges 23, 25.

As depicted, the slot is open along the first and second edges 23, 25, which extend in a lengthwise direction of the elongate attachment member 20 and as a result the cover portion slides in a direction perpendicular to the longitudinal axis of the attachment member. However, in an alternative arrangement, the slot may open at ends of the elongate attachment member (as opposed to along the edges) and the cover portion may slide into the slot in a direction parallel to the longitudinal axis of the attachment member.

The attachment member 20 and cover portion 40 may be configured such that there is an interference fit between the attachment member and cover portion 40. The interference fit may be provided by a pair of projections 42a, 42b provided at ends of the cover portion 40. The projections 42a, 42b may engage corresponding ends 28a, 28b of the slot 28 when the cover portion 40 is fully inserted into the slot 28. The projections 42a, 42b may be configured such that friction between the projections 42a, 42b and the ends 28a, 28b of the slot ensures that the cover portion 40 may not unintentionally fall out of the slot 28. However, the engagement between the projections 42a, 42b and the ends 28a, 28b of the slot may be overcome when a user attempts to manually remove the cover portion 40 from the slot 28. The transfer portion 60 may comprise corresponding projections 62a, 62b, which engage the ends 28a, 28b of the slot 28 in a similar manner to that described above in respect of the cover portion projections 42a, 42b. In either case, the projections 42a, 42b, 62a, 62b may be provided at an edge of the respective cover portion 40 and transfer portion 60 such that the projections only engage the ends 28a, 28b of the slot when the respective cover portion or transfer portion is fully inserted into the slot.

At least a lengthwise portion of the slot 28 may have a width that is greater than a corresponding width of the cover portion 40 and/or transfer portion 60. In particular, the attachment member 20 may comprise pairs of overhanging portions 30a, 30b on the first edge 23 and at respective first and second ends 28a, 28b of the slot. Pairs of overhanging portions 31a, 31b may be similarly provided along the second edge 25 at respective first and second ends 28a, 28b of the slot 28. Each pair of overhanging portions comprises an overhanging portion on the first side 22 and a corresponding overhanging portion on the second side 24. The pairs of overhanging portions 30a, 30b, 31a, 31b may receive a portion of the cover portion 40 or transfer portion 60 when the other of the cover portion 40 and transfer portion 60 is fully inserted in the slot 28. The attachment member 20 may otherwise be set back in a width-wise direction such that the width of the attachment member 20 is less than the corresponding width of the cover portion 40 or transfer portion 60. The setback regions may expose an edge of the cover portion 40 or transfer portion 60 when the respective cover portion and transfer portion are fully inserted into the slot. Exposure of the edges at the setback region may assist the user in grasping the cover portion 40 or transfer portion 60 to manually remove the cover portion or transfer portion from the slot 28.

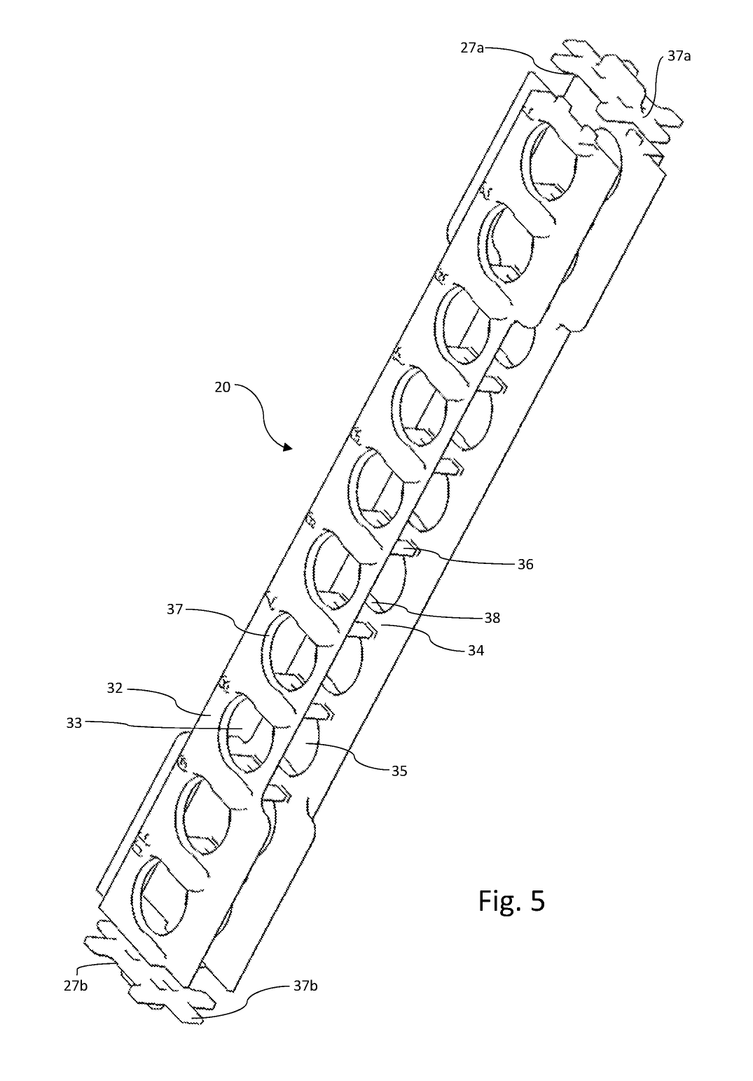

As is best depicted in FIGS. 2 and 5, the attachment member 20 may comprise a first side wall 32 and a second side wall 34. The slot 28 may be provided between the first and second side walls 32, 34. The first side wall 32 comprises one or more openings 33 and the second side wall 34 comprises one or more corresponding openings 35. The corresponding openings 33, 35 in the side walls 32, 34 are opposite one another so as to define the passage 26 through the attachment member 20 between first and second vials. In the particular arrangement shown, the first and second side walls 32, 34 each comprise a plurality of corresponding openings 33, 35, for example each side wall may comprise ten openings. However, it will be appreciated that the side walls may comprise any number of openings.

The attachment member 20 may comprise dividing walls 36 between neighbouring pairs of corresponding openings 33, 35. Accordingly, the dividing walls 36 may extend across the slot 28 and, in addition to the corresponding openings 33, 35, may define each of the passages 26 through the attachment member 20. The dividing walls 36 may be provided between neighbouring openings 33, 35 provided along the length of the attachment member 20. The dividing walls 36 may also extend in a width-wise direction across the width of the attachment member 20.

The cover portion 40 may comprise one or more slits 44 configured to receive a corresponding dividing wall 36. The slits 44 may extend partially across the width of the cover portion 40 and may extend from an edge of the cover portion 40 that is to be inserted into the attachment member 20 first. The slits 44 may be chamfered at the edge of the cover portion that is first inserted into the attachment member 20. An interaction between the dividing walls 36 and the slits 44 may limit the extent to which the cover portion 40 may be inserted into the attachment member slot 28. This interaction may ensure that the cover portion 40 may not be inserted beyond the fully inserted position. In a similar manner, the transfer portion 60 may also comprise slits 64 which are configured to receive the corresponding dividing wall 36. An open end of the slits 64 may also be chamfered and the slits 64 may interact with the dividing walls 36 so as to limit the insertion of the transfer portion into the attachment member 20.

In addition to the dividing walls 36, the attachment member 20 may comprise first and second end walls 37a, 37b provided at ends of the attachment member 20 and which form the first and second ends 28a, 28b of the slot 28 respectively.

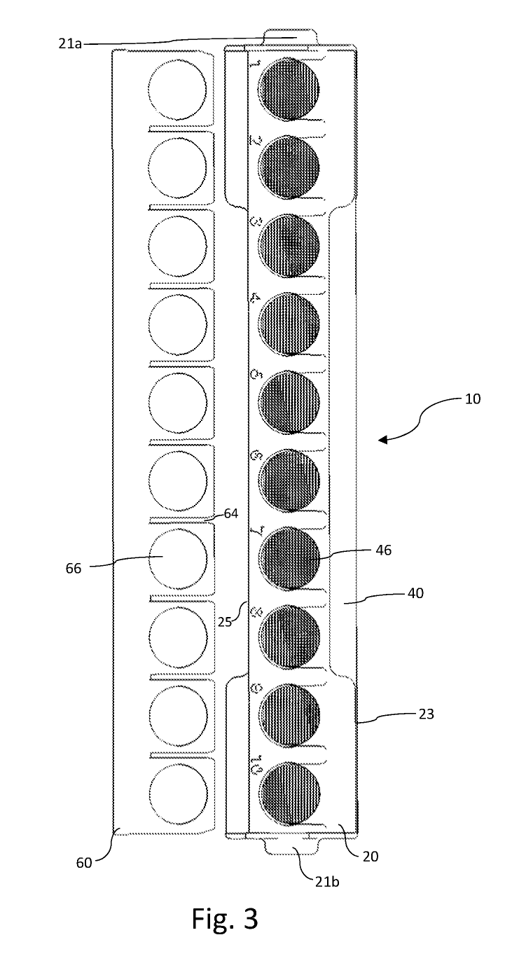

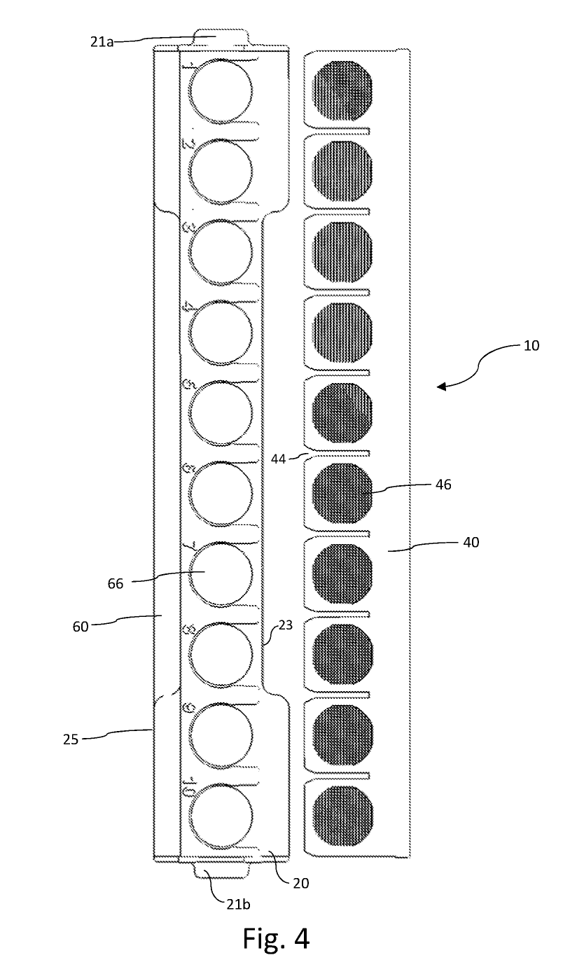

As depicted in FIGS. 1 and 4, the cover portion 40 comprises one or more mesh sections 46. In the particular example shown, the cover portion 40 comprises a plurality of mesh sections 46 distributed along the length of the cover portion and the number of mesh sections 46 corresponds to the number of openings 33, 35 in each of the side walls 32, 34. The slits 44 are provided between neighbouring mesh sections 46. The mesh sections 46 are positioned so as to overlap with the openings 33, 35 when the cover portion 40 is in the fully inserted position as depicted in FIG. 3. The mesh sections 46 may be substantially circular and may thus correspond, e.g. in size, to the circular openings 33, 35. The mesh sections 46 are configured to restrict the passage 26 through the attachment member 40. In particular, the mesh sections 46 may comprise openings that are sized to prevent the escape of insects (or their larvae) from the vial but permit the flow of air into the vial. The mesh sections 46 may be made from plastic or metal wire. The mesh sections 46 may be integral with the remainder of the cover portion 40, e.g. the mesh sections 46 and remainder of the cover portion 40 may be made from the same plastic material.

The transfer portion 60 may comprise one or more openings 66 configured to permit the transfer of insects through the passage 26. In the particular example shown, the transfer portion 60 comprises a plurality of openings 66 distributed along the length of the transfer portion and the number of openings corresponds to the number of openings 33, 35 in each of the first and second side walls 32, 34. The openings 66 may overlap with the openings 33, 35 when the transfer portion 60 is fully inserted into the slot 28. The openings 66 may be substantially circular and may correspond, e.g. in size, to the circular openings 33, 35. Each of the openings 66 may be provided between neighbouring slits 64. When the transfer portion 60 is fully inserted into the attachment member 20, the transfer of insects from a first vial attached to the first side 22 of the attachment member to a second vial attached to the second side 24 of the attachment member may be permitted. In other words the opening 66 in the transfer portion 60 opens the passage 26 through the attachment member 20.

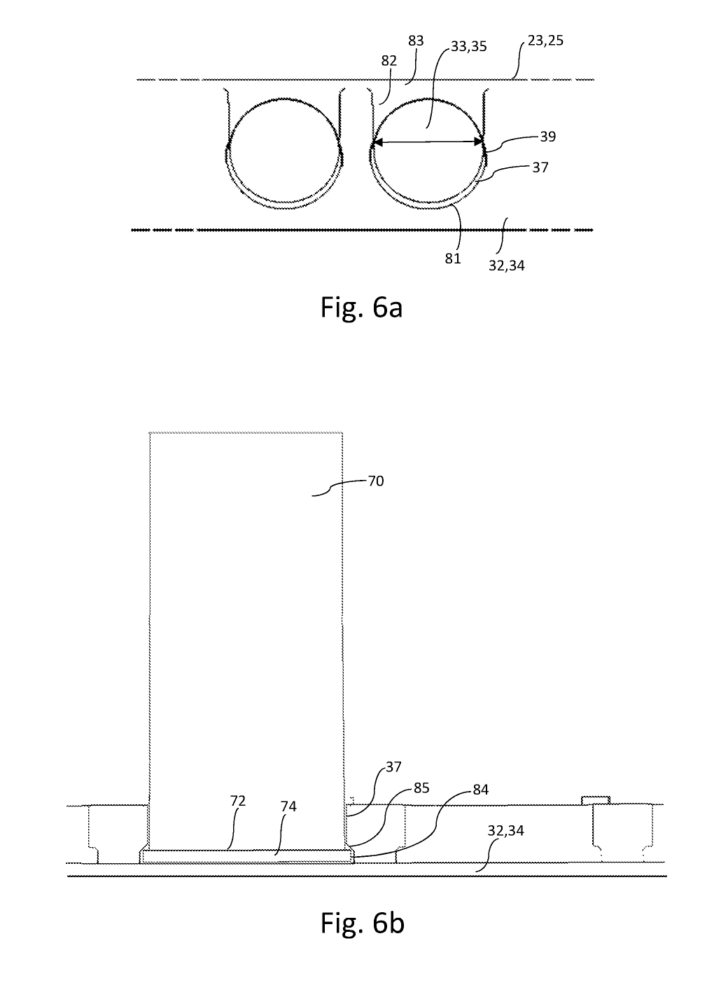

With reference to FIGS. 6a and 6b, each of the first and second sides 22, 24 of the attachment member comprises one or more engaging portions 37, 38. In the particular example depicted, the attachment member 20 comprises a plurality of engaging portions 37, 38 distributed along the length of the attachment member and the number of engaging portions 37, 38 on each of the sides 22, 24 corresponds to the number of passages 26 through the attachment member 20. FIGS. 6a and 6b show only one of the side walls 32, 34 and it will be appreciated that the same arrangement applies to the other of the side walls 32, 34. The engaging portions 37, 38 may be configured to selectively and sealingly engage an open end 72 of a vial 70. Each of the engaging portions 37, 38 may be associated with one of the openings 33, 35 in the side walls 32, 34 and the engaging portions 37, 38 may be configured to selectively and sealingly engage the open end 72 of the vial 70 around the associated opening 33, 35.

The openings 33, 35 in the side walls 32, 34 may be substantially circular, e.g. so as to correspond to the circular cross section of the vial 70. A diameter of the openings 33, 35 may substantially correspond to an inner diameter of the vial 70. A rim 74 of the vial 70 may rest on the side wall 32, 34 at the edge of the opening 33, 35. The engaging portions 37, 38 may be configured such that the open end of the vial 72 overlaps with the opening 33, 35 so insects may not escape during the transfer process between the vials. The diameter of the openings 33, 35 may be less than the inner diameter of the vial 70, although this may create a ledge which might interrupt the free flow of the insects from one vial to another. It will be appreciated that other shapes of vials and openings may be provided, for example square openings may be provided for vials with a square cross-section. The engaging portions 37, 38 may be adjusted accordingly.

The engaging portions 37, 38 may be configured to engage the vial 70 by virtue of a snap fit. For example, the vial 70 may be slid into place past a narrowing 39 in the engaging portions 37, 38. The narrowing 39 may be narrower than a particular standard vial outer diameter, which the attachment member is configured to engage. The engaging portions 37, 38 may comprise a side wall 81 that engages a side of the vial 70. The engaging portion side wall 81 may be formed by a recess 82 in the attachment member side wall 32, 34. The recess 82 may be provided about a particular opening 33, 35. The recess 82 may define an open end 83 along an edge 23, 25 of the side wall 32, 34. The vial 70 may be inserted through the open side 83 of the recess 82 by sliding the open end 72 of the vial against the attachment member side wall 32, 34. The engaging portion side wall 81 may define the narrowing 39 which the vial 70 may resiliently be pushed past. Beyond the narrowing 39, the engaging portion side wall 81 may follow the shape of the vial 70 and may engage the outer wall of the vial 70 and hold the vial 70 in place. For example, the engaging portion side wall 81 may define a circular arc beyond the narrowing 39.

The engaging portions 37, 38 may comprise a groove 84 along a bottom edge of the recess 82. The groove 84 may undercut the engaging portion side wall 81. The groove 84 may receive the rim 74 of the vial. The groove 84 and rim 74 may interact such that the vial 70 may not be pulled out of engagement with the attachment member 20. Accordingly, the groove 84 may define a shoulder 85, which a corresponding shoulder on the vial rim 74 may engage. Alternatively, the engaging portion side wall 81 may be tapered such that the width of the recess 82 is wider at the bottom of the recess. Such a taper may also accommodate the rim 74 of the vial 70.

The vial 70 may pass the narrowing 39 by virtue of the vial being resilient and thereby resiliently deforming as the vial is slid past the narrowing 39. Additionally or alternatively, the engaging portion side wall 81 may be resilient such that the engaging portion side wall 81 resiliently deforms as the vial is slid past the narrowing 39.

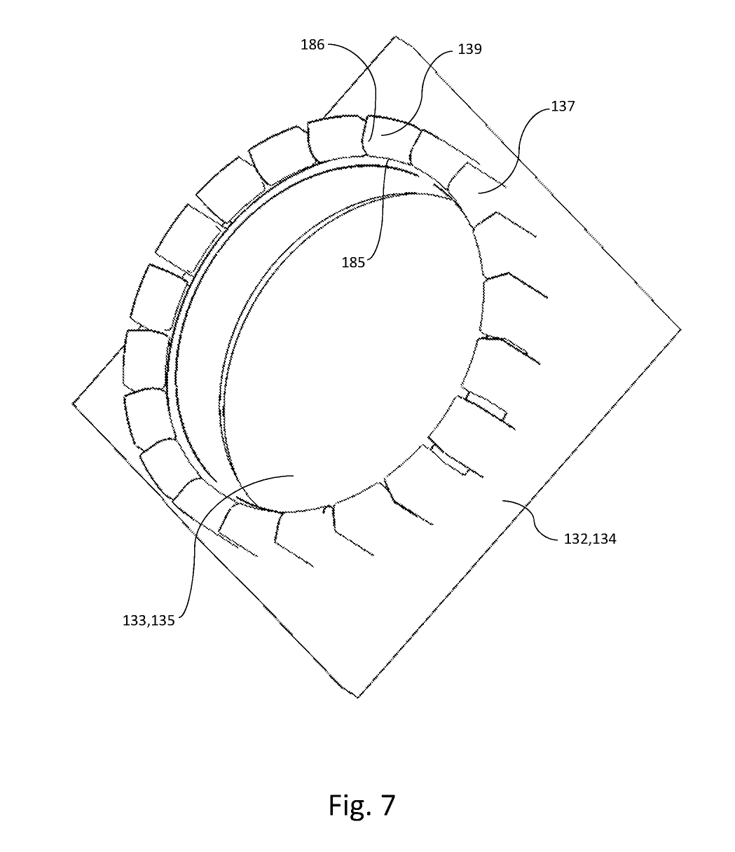

With reference to FIG. 7, an alternative engaging portion 137 is depicted. In contrast to the aforementioned engaging portions 37, 38, the vial 70 is pushed into engagement with the alternative engaging portion 137. For example, the vial 70 is pushed in a direction substantially parallel to a longitudinal axis of the vial when inserted into the alternative engaging portion 137. (By contrast, the vial 70 may be moved in a direction perpendicular to the longitudinal axis of the vial 70 when engaging the aforementioned engaging portions 37, 38.) The alternative engaging portion 137 comprises a plurality of resiliently deformable teeth 139 disposed about a particular opening 33, 35 in the attachment member side wall 32, 34. The teeth 139 each comprise an abutment shoulder to engage the rim 74 of the vial 70. The teeth 139 may comprise a ramped surface 186, which moves the teeth 139 radially outwards as the open end 72 of the vial 70 is pushed into the engaging portion 137. The teeth 139 may snap back once the vial rim 74 has passed the radially inner edge of the ramped portion 186, which forms a narrowing of the engaging portion 137. Each of the teeth 139 may be integral with the corresponding attachment member side wall 32, 34, although the teeth 139 may be independently movable with respect to one another. The teeth 139 may be disposed circumferentially so as to define an aperture through which the open end 72 of the vial may pass. Although FIG. 7 shows only one engaging portion 137, it will be appreciated that a plurality of such engaging portions may be provided e.g. with one for each opening 33, 35 in the respective side wall 32, 34.

The attachment member slot 28 may interchangeably receive the cover portion 40 and transfer portion 60. For example, FIG. 3 depicts the cover portion 40 fully inserted into the attachment member slot 28 and FIG. 4 shows the transfer portion 60 fully inserted into the attachment member slot 28. The cover portion 40 has been inserted into the slot 28 at the first edge 23 of the attachment member 20 and the transfer portion 60 has been inserted into the slot 28 at the second edge 25 of the attachment member. However, either of the cover portion and transfer portion may be inserted into the slot via either of the first and second edges. Pushing the transfer portion 60 into the slot 28 may in turn push the cover portion 40 out of the slot 28.

Likewise, pushing the cover portion 40 into the slot 28 may push the transfer portion 60 out of the slot 28. As depicted, the cover portion 40 and transfer portion 60 are separate components. This may be convenient if wishing to clean these components, in particular the mesh sections 46 of the cover portion 40. However, it is equally envisaged that the cover portion 40 and transfer portion 60 may be unitary, e.g. integral, such that a single component may be slid back and forth in the attachment member slot 28. It is also envisaged that the transfer portion 60 may be omitted, for example the cover portion 40 may be constrained from leaving the slot 28 and the slot may only be open along one of the edges 23, 25.

As depicted in FIG. 5, each of the first and second side walls 32, 34 comprises the overhanging portions 30a, 30b, 31a, 31b such that the slot 28 has a greater width in the region where the overhanging portions are provided. Accordingly, when the cover portion 40 or transfer portion 60 push out the other of the cover portion 40 and transfer portion 60, the other of the cover portion and transfer portion 60 may still be held by the overlapping portions 30a, 30b, 31a, 31 b. Similarly, prior to fully inserting the cover portion 40 or transfer portion 60, the overlapping portions 30a, 30b, 31a, 31b may be used to conveniently hold the cover portion 40 or transfer portion 60 in an initial position prior to insertion.

Referring again to FIG. 5, the attachment member 20 may be made from a number of individual components that are slotted together. For example, the attachment member 20 may be formed from the first and second side walls 32, 34, the first and second end walls 37a, 37b and the dividing walls 36. These components may have corresponding projections and openings that slot together upon assembly. These components may be moulded, 3-D printed or formed in any other way. Alternatively, the attachment member 20 may itself be moulded, 3-D printed or formed in any other way and may be formed from a single component. The attachment member may be made from a plastic material. The cover portion 40 and/or transfer portion 60 may also be formed from a plastic material. The cover portion 40 and/or transfer portion 60 may also be moulded, 3-D printed or formed in any other way.

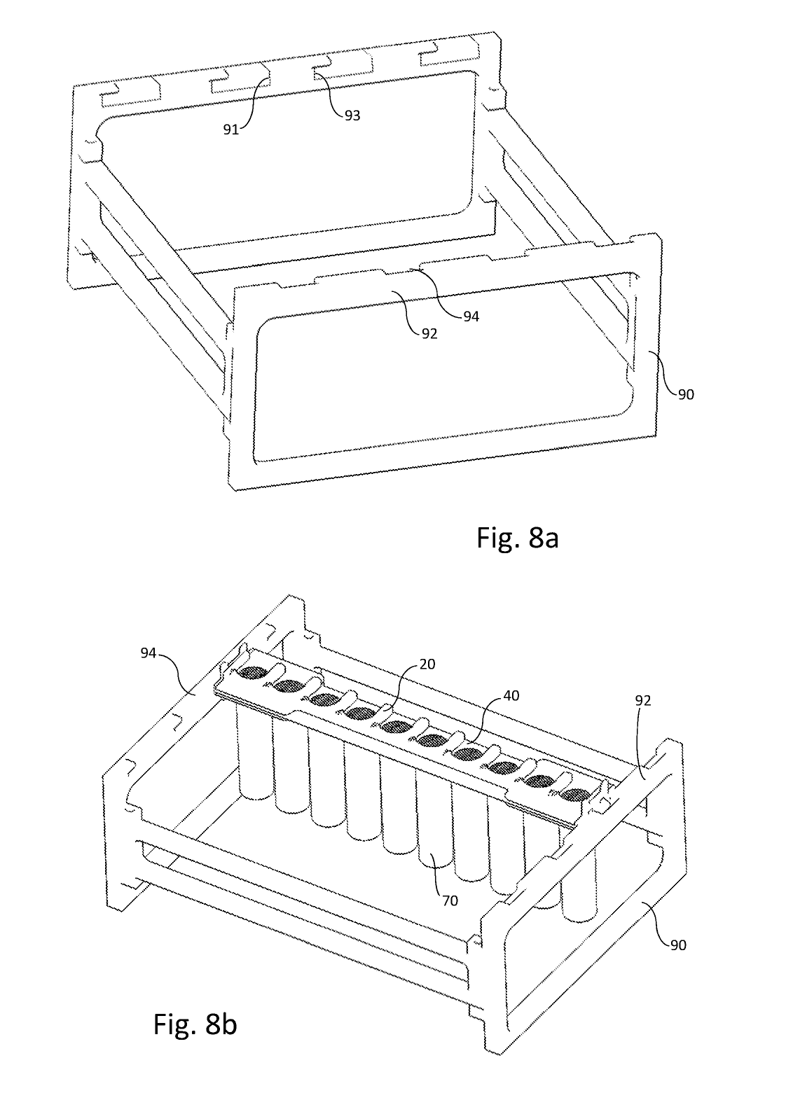

Referring now to FIGS. 8a and 8b, the tipping assembly 10 may further comprise a rack 90 configured to support ends of the attachment member 20. The rack 90 may comprise a pair of spaced apart rails 91, 92 which support respective ends of the attachment member 20. Each rail 91, 92 may comprise one or more grooves 93, 94, which are configured to receive a tab 21a, 21b provided on respective end walls 37a, 37b of the attachment member 20. The tabs 21a, 21b may extend in a longitudinal direction of the attachment member 20 and may be shaped so as to pass through an opening 93a, 94a of the groove 93, 94 and slide into an end 93b of the groove 93, 94 where the attachment member 20 may be held in place as the rack 90 is rotated. The grooves 93, 94 may be configured such that the attachment member 20 is moved in a first direction as the tabs 21a, 21b pass through the opening 93a, 94a of the grooves 93, 94 and moves in a second direction as the tabs 21a, 21b move to the end 93b of the groove 93, 94. FIG. 8a shows the rack 90 without the attachment member 20 installed, whereas FIG. 8b shows the rack with the attachment member 20 installed along with the cover portion 40 and a plurality of vials 70.

The tipping assembly 10 may further comprise one or more of the vials 70. The vials may be made from a plastic material and the vials may be transparent. The vials may be standard in size, e.g. with a standard outer diameter, such as 24 mm, 25 mm or 28.5 mm. Alternatively, the vials may have a non-standard outer diameter. The vials 70 may also have a standard rim 74, for example a rounded rim, or a non-standard rim that may be bespoke for the tipping assembly 10, for example a rim having a square profile. It will be appreciated that the vials may also be provided separately from the tipping assembly 10.

As shown in FIG. 1, each of the openings 33, 35 in the side walls 32, 34 may be labelled, e.g. with a number. Such labels may assist the user in identifying the insects being stored in an associated vial. The label may be integral with the respective side wall 32, 34, for example the label may be moulded or etched or formed into or onto the respective side wall.

Returning to FIG. 5, the ends of the attachment member 20 may comprise finger holds 27a, 27b. The finger holds 27a, 27b may be provided at each end of the attachment member 20 and on each side of the attachment member. The finger holds may assist the user in gripping the attachment member with their fingers and assist in rotation of the attachment member 20 about its longitudinal axis. The user may thus readily grip the attachment 20 at the end of the attachment member away from the vials and may in a single action rotate the attachment member 20.

The attachment member 20 may possess rotational symmetry about its longitudinal axis such that the recess openings 83 of the engaging portions 37, 38 on the first and second sides 22, 24 are provided on opposite edges 23, 25. Accordingly, vials connected to a top surface of the attachment member 20 may be slid in the same direction into engagement regardless of which of the first and second sides is the top surface.

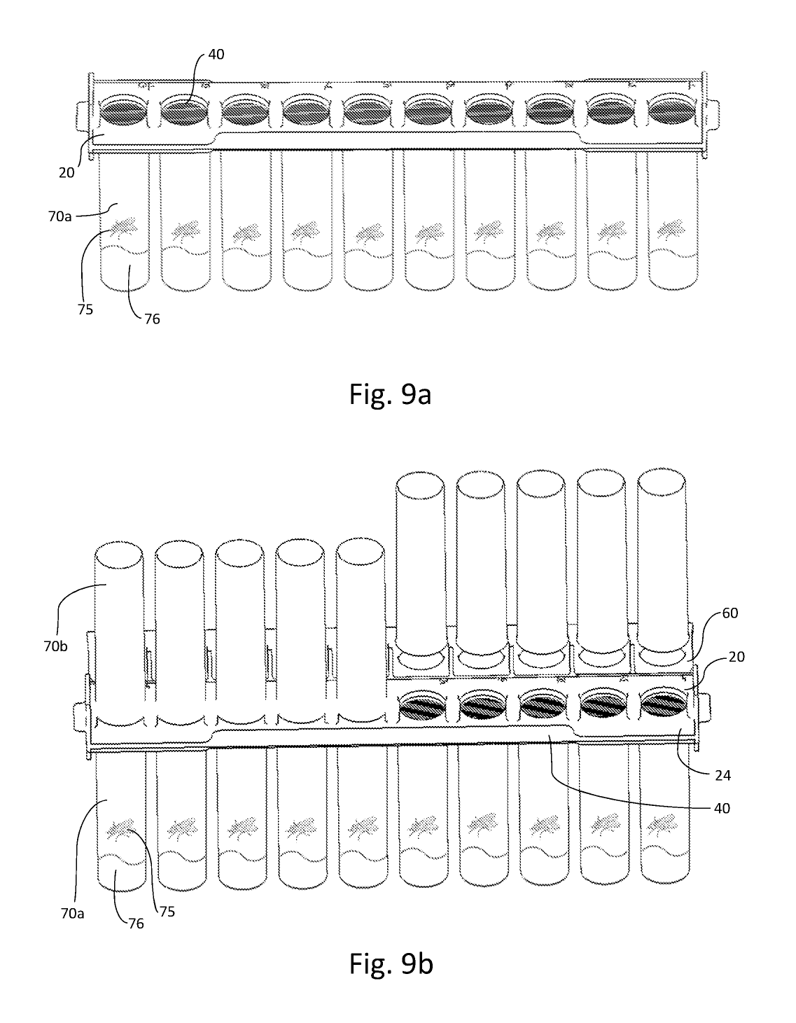

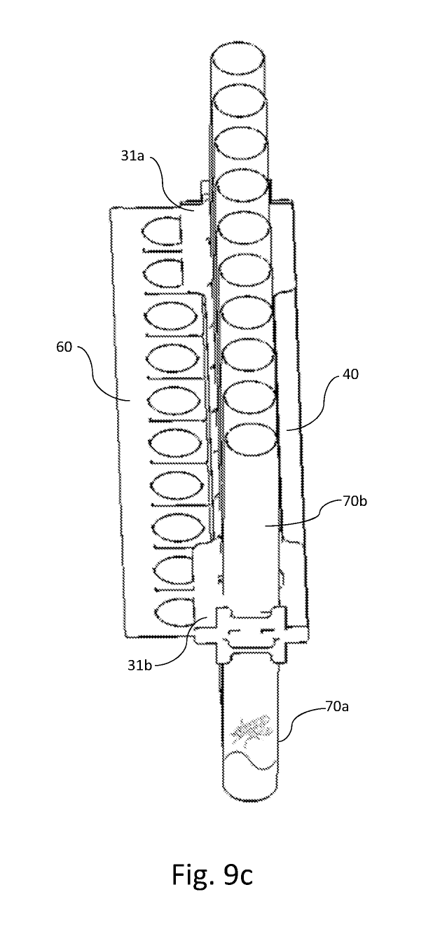

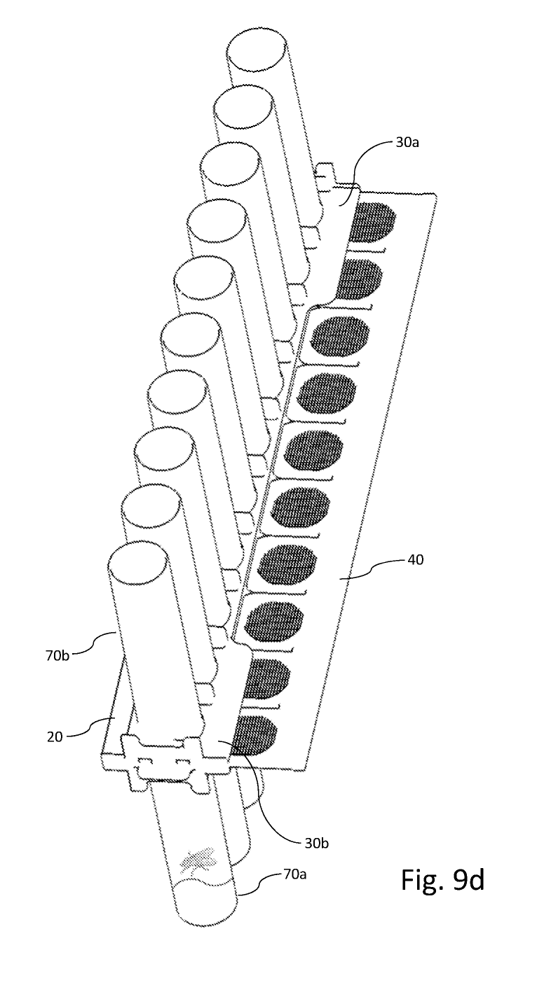

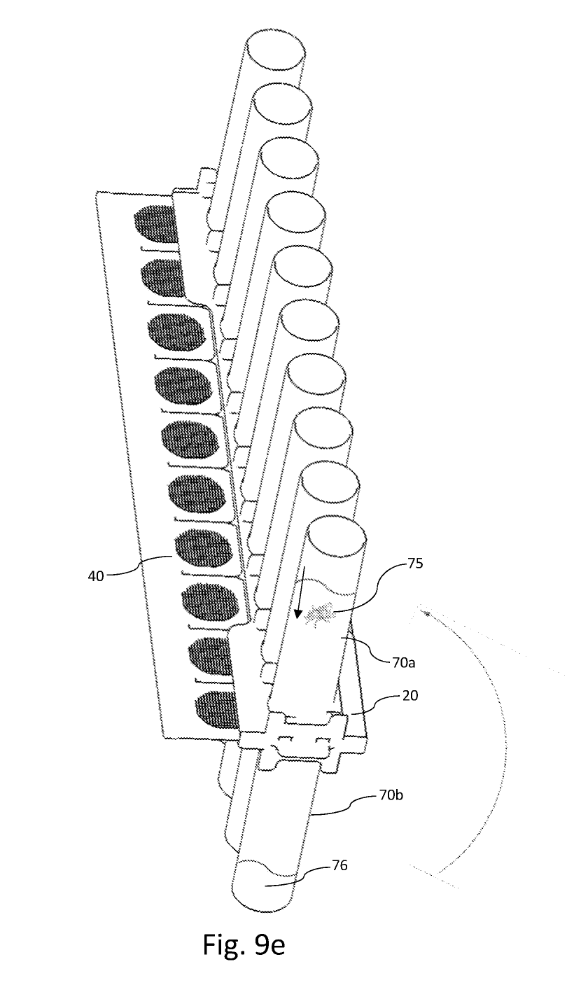

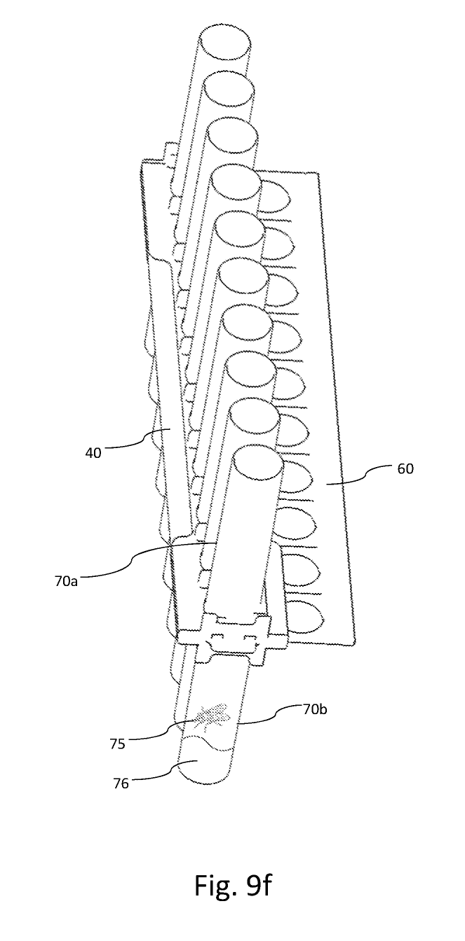

Referring now to FIGS. 9a-f, operation of the turning assembly 10 will be described. As shown in FIG. 9a, a plurality of first vials 70a may be attached to the attachment member 20. The cover portion 40 may be in the inserted position in the attachment member slot such that insects 75 and food 76 may be held in the vials 70a.

As depicted in FIG. 9b, when it is necessary to transfer the insects 75 to a new vial, a plurality of the second vials 70b may be attached to the second side 24, which is at that point the top side of the attachment member 20. The second vials 70b may be slid into place in the engaging portions 38 in the manner described above. The transfer portion 60 may also be provided in readiness for interchanging with the cover portion 40.

As shown in FIG. 9c, the transfer portion 60 may be partially inserted into the slot 28 by virtue of the overhanging portions 31a, 31b. However, the cover portion 40 may remain fully inserted in the attachment member slot 28.

As shown in FIG. 9d, when the user wishes to transfer the insects from the first vials 70a to the second vials 70b, the user may push the transfer portion 60 into the slot 28, thereby displacing the cover portion 40 and opening the passages 26 through the attachment member 20. The cover portion 40 may remain partially engaged in the slot 28 by virtue of the overhanging portions 30a, 30b.

As depicted in FIG. 9e, the user may then rotate the assembly about its longitudinal axis so that the insects fall from the first vials 70a through the passages 26 and into the second vials 70b. Fresh food may be provided in the second vials 70b.

Once all the insects have been transferred from the first vials 70a to the second vials 70b the cover portion 40 may be re-inserted into the attachment member slot 28 such that the transfer portion 60 is displaced. The insects in the second vials 70b may thus be prevented from leaving the second vials 70b by the cover portion 40, as depicted in FIG. 9f. The first vials 70a are now provided above the second vials 70b. The first vials may be removed and either discarded or cleaned. The process may be repeated when it is subsequently desired to transfer the insects 75 to further vials.

During the transfer process the cover portion 40 may be removed and either cleaned or replaced with a clean cover portion 40. The vials may be kept attached to the attachment member 20 during the time that the insects are inside the vial and the cover portion 40 may remain installed to prevent the insects or their larvae from escaping. As shown in FIG. 8b the rack 90 may hold the attachment member 20 and installed vials 70. The rack may be rotated, e.g. by 90°, if it is desired to move the vials from a vertical position to a horizontal position.

The method may further comprise performing a negative geotaxis (or gravitaxis or climbing) assay on insects in one or more of the vials 70 attached to the attachment member 20. For example, the insects may be transferred from first vials 70a to second vials 70b using the method described above. The second vials 70b may or may not have food for the insects, but may be used for carrying out a geotaxis assay on the insects. For example, the second vials 70b may be tapped on a surface to encourage the insects to fall to the bottom of the second vials. The insects may then be given a certain period of time, e.g. between 45 and 60 seconds, to ascend the second vials 70b. The height of the insect within each vial may then be recorded. Such measurements may indicate the health or strength of the particular insect, which may in turn be used to indicate the longevity of a particular strain of insect. The tipping assembly 10 may conveniently permit the geotaxis assay to be performed on a number of insects at the same time. The insects may also be conveniently transferred from a vial with food to another vial, which is to be used for the assay, and then back to a vial with food (whether that is the original vial or a fresh one). The vials to be used in the geotaxis assay may be a particular size, e.g. a certain height, which is appropriate for the particular assay that is to be carried out.

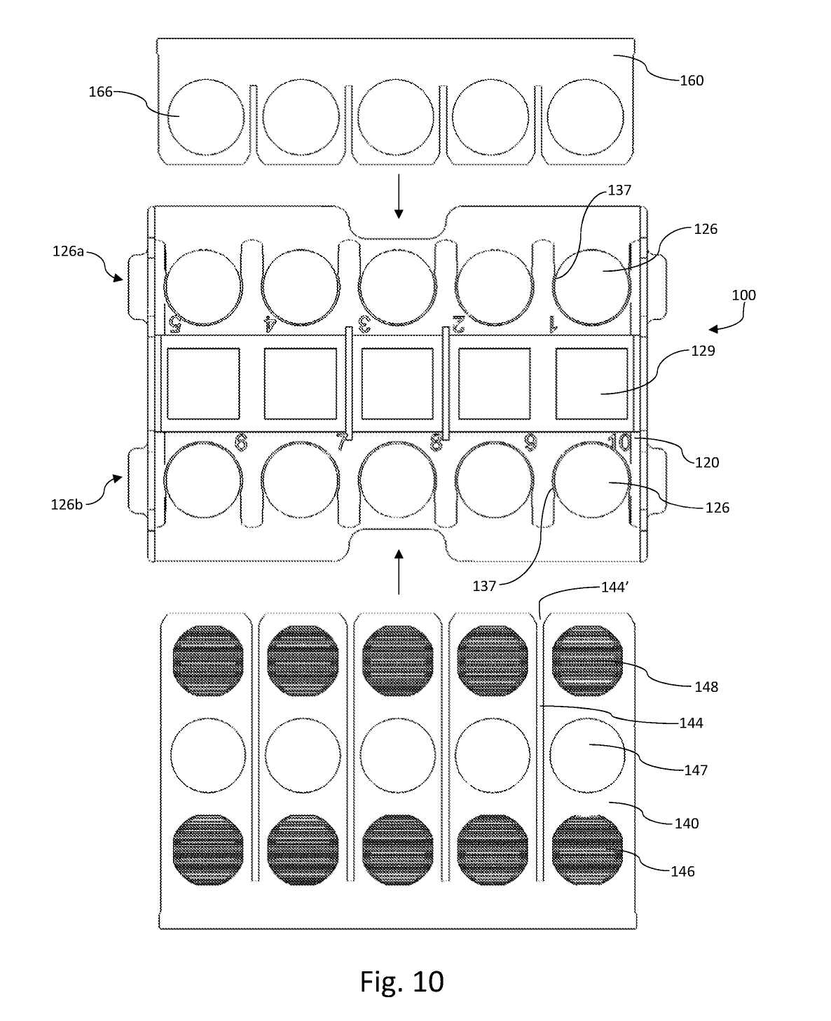

Referring now to FIG. 10, an alternative tipping assembly 100 will be described. The attachment member 120 may comprise first and second rows 126a, 126b of passages 126. (Although not shown, further rows of passages may be provided in other alternative arrangements.) Each row may comprise one or more passages 126 (e.g. five in the example shown). The second row 126b may be arranged alongside, e.g. adjacent to, the first row 126a, such that corresponding passages 126 may be aligned thereby forming a matrix of passages. Such an arrangement may permit more vials to be attached to the attachment member without necessarily increasing the length of the attachment member.

The first and second rows 126a, 126b may be spaced apart in the width-wise direction of the attachment member 120. The slot may also extend across the width of the attachment member 120 such that the slot is present at and between the first and second rows 126a, 126b. The attachment member 120 may comprise a row of one or more openings 129 in the space between the first and second passage rows 126a, 126b. The openings 129 may be aligned with corresponding passages 126. The openings 129 may be provided on each side wall of the attachment member 120 so that the openings 129 extend though the attachment member 120.

The openings 129 may permit the user to see the cover portion 140 or transfer portion 160 when they are in the space between the first and second rows 126a, 126b.

The engaging portions 137 for each of the rows 126a, 126b may open out towards a corresponding edge of the attachment member 120 such that for each row the vials may be inserted in a direction towards the space between the rows 126a, 126b. In this way, the vials may be readily attached to the attachment member 120.

The attachment member 120 is otherwise similar to the attachment member 20 described above and the description of common features will not be duplicated here.

The alternative tipping assembly 100 comprises a cover portion 140 that comprises a plurality of mesh sections 146 arranged in a row. The cover portion 140 may further comprise a plurality of openings 147 configured to permit the transfer of insects from the first vials to the second vials respectively. The plurality of openings 147 may be arranged in a row alongside the row of mesh sections 146. The individual openings in the row of openings 147 may be aligned with individual mesh sections in the row of mesh sections 146. The cover portion 140 may also comprise a further row of mesh sections 148. The further row of mesh sections 148 may be arranged alongside the row of openings 147 in the cover portion and the mesh sections in the further row of mesh sections 148 may be aligned with respective openings in the row of openings. The row of openings 147 may be disposed between the row of mesh sections 146 and the further row of mesh sections 148. Slits 144 extend partially across the width of the cover portion 140 and each slit extends between neighbouring mesh sections 146, neighbouring openings 147 and neighbouring further mesh sections 148. The further mesh sections 148 are provided adjacent to a mouth 144′ of the slits 144 in the cover portion 140 and the mesh sections 146 are furthest from the mouth 144′.

The tipping assembly 100 may also comprise the transfer portion 160, which corresponds to the transfer portion 60 described above, e.g. with a single row of openings 166.

To prevent the transfer of insects between the first and second vials, the cover portion 140 may be fully inserted into the attachment member 120 such that the mesh sections 146 cover the second row of passages 126b respectively and the further mesh sections 148 cover the first row of passages 126a respectively. To permit the transfer of insects between the first and second vials, the transfer portion 160 may be fully inserted into the attachment member 120. In doing so, the transfer portion 160 may push against and move (e.g. retract) the cover portion 140 such that the mesh sections 146 no longer cover the second row of passages 126b and the further mesh sections 148 no longer cover the first row of passages 126a. Instead, when the transfer portion 160 is fully inserted, the row of openings 166 in the transfer portion overlaps the first row of passages 126a and the row of openings 147 in the cover portion 140 overlaps the second row of passages 126b, thereby permitting the transfer of insects through the passages. The assembly 100 may revert to a closed position by pushing back the cover portion 140 to the fully inserted position.

Instead of the transfer portion 160, a second cover portion 140 may also be inserted into the attachment member 120 to displace a first cover portion 140. This may allow the first cover portion 140 to be removed and cleaned.

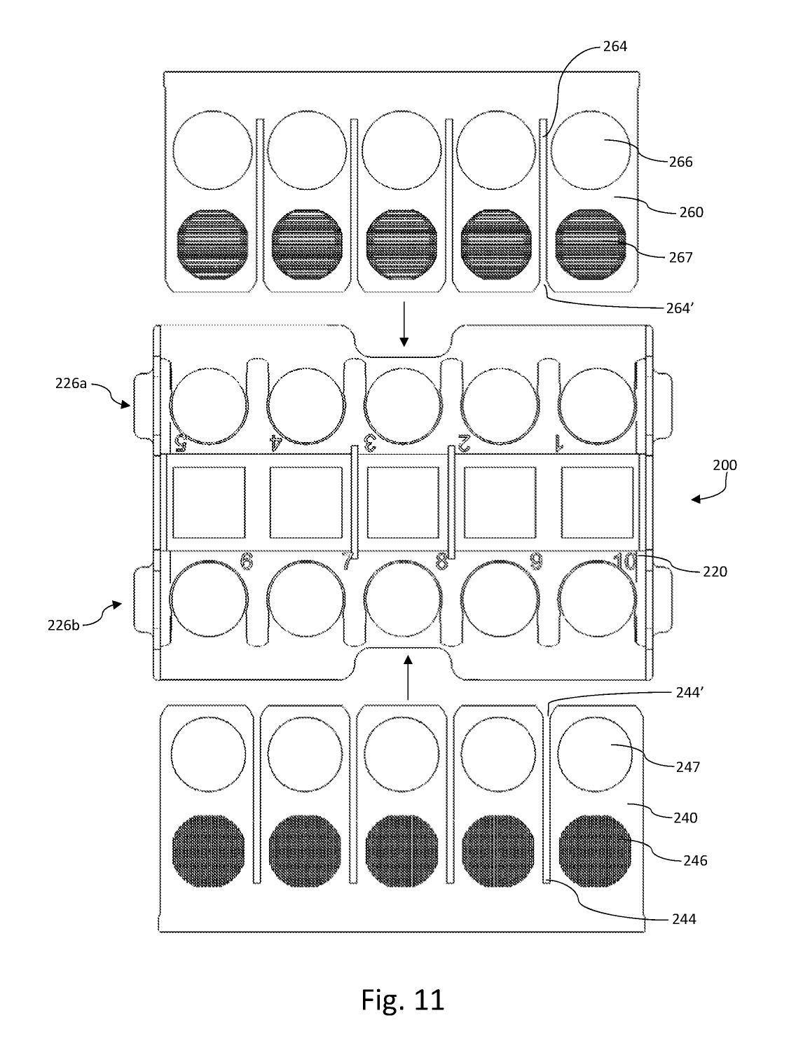

Referring now to FIG. 11, a further alternative tipping assembly 200 will be described. The attachment member 220 corresponds to the attachment member 120 described above. The cover portion 240 is similar to the cover portion 140 described above, except that the further row of mesh sections has been omitted. As such, the cover portion 240 comprises a plurality of mesh sections 246 arranged in a row and a plurality of openings 247 arranged in a row alongside the row of mesh sections 246. The openings 247 are provided adjacent to a mouth 244′ of the slits 244 in the cover portion 240 and the mesh sections 246 are furthest from the mouth 244′.

The transfer portion 260 is similar to the transfer portion 160 described above, except that a further row of mesh sections 267 has been added. As such, the transfer portion 260 comprises a plurality of openings 266 arranged in a row and a plurality of mesh sections 267 arranged in a row alongside the row of mesh sections 267. The mesh sections 267 are provided adjacent to a mouth 264′ of the slits 264 in the transfer portion 260 and the openings 266 are furthest from the mouth 264′. Accordingly, the transfer portion 260 is similar to the cover portion 240 except that the mesh sections and openings have been swapped round. As a result, the transfer portion 260 may also be referred to as a cover portion.

To prevent the transfer of insects between the first and second vials, the cover portion 240 may be fully inserted into the attachment member 220 such that the mesh sections 246 cover the second row of passages 226b respectively and the transfer portion 260 may be partially inserted into the attachment member 220 such that the mesh sections 267 cover the first row of passages 226a respectively. To permit the transfer of insects between the first and second vials, the transfer portion 260 may be fully inserted into the attachment member 220. In doing so, the transfer portion 260 may push against and move (e.g. retract) the cover portion 240 such that the mesh sections 246 no longer cover the second row of passages 226b and the mesh sections 267 no longer cover the first row of passages 226a. Instead, when the transfer portion 260 is fully inserted, the row of openings 266 in the transfer portion overlaps the first row of passages 226a and the row of openings 247 in the cover portion 240 overlaps the second row of passages 226b, thereby permitting the transfer of insects through the passages. The assembly 200 may revert to a closed position by pushing back the cover portion 240 to the fully inserted position.

The tipping assembly 10 described herein is advantageous because it reduces the amount of time required to transfer insects from one vial to another, particularly when performing this action for a plurality of vials. The transfer of insects from one vial to another can be processed in a single action. The assembly and process described herein is also reliable since it is not possible for the insects to escape as they are permanently sealed in the vials. The turning assembly described herein is also manually operable by a user and avoids the cost of a robotic system. The cover portion 40 is also reusable and cleanable which avoids consuming disposable covers or plugs.

It will be appreciated by those skilled in the art that although the invention has been described by way of example, with reference to one or more examples, it is not limited to the disclosed examples and alternative examples may be constructed without departing from the scope of the invention as defined by the appended claims.

1-36. (canceled)

37. A tipping assembly for transferring insects from one or more first vials to one or more second vials, the tipping assembly comprising:
an attachment member comprising a first side to which the one or more first vials are selectively attachable and a second side to which the one or more second vials are selectively attachable; and
a cover portion configured to be slidably received in a slot in the attachment member,
wherein the attachment member defines one or more passages therethrough for the selective transfer of insects from the one or more first vials to the one or more second vials respectively when the cover portion is in a retracted position, and
wherein the cover portion is configured to restrict the one or more passages through the attachment member when the cover portion is in an inserted position in the slot, and the cover portion comprises one or more mesh sections, the one or more mesh sections being configured to restrict the one or more passages through the attachment member when the cover portion is in the inserted position in the slot.

38. The tipping assembly of claim 37, wherein the attachment member comprises a first side wall and a second side wall spaced apart from the first side wall so as to define the slot therebetween, each of the first and second side walls comprising one or more openings, the or each opening in the first side wall being opposite a corresponding opening in the second side wall; and wherein the or each passage is at least partially defined by corresponding openings in the first and second side walls.

39. The tipping assembly of claim 37, wherein each of the first and second sides comprises one or more engaging portions, wherein the engaging portions are configured to selectively and sealingly engage an open end of the first or second vial.

40. The tipping assembly of claim 39, wherein the engaging portions are configured to engage the first or second vial by virtue of a snap fit.

41. The tipping assembly of claim 37, wherein the tipping assembly further comprises a transfer portion configured to be slidably received in the slot, the transfer portion comprising one or more openings configured to permit the transfer of insects from the one or more first vials to the one or more second vials respectively when the transfer portion is in an inserted position in the slot.

42. The tipping assembly of claim 41, wherein the attachment member slot is configured to alternatingly receive the cover portion and transfer portion.

43. The tipping assembly of claim 41, wherein the cover portion and transfer portion are one of separate components and unitary.

44. The tipping assembly of claim 41, wherein at least a lengthwise portion of the attachment member slot has a width greater than a corresponding width of at least one of the cover portion and transfer portion such that the slot can receive one of the cover portion and transfer portion and at least a portion of the other of the cover portion and transfer portion.

45. The tipping assembly of claim 41, wherein at least one of the attachment member and transfer portion are configured such that the attachment member and transfer portion fit together with an interference fit.

46. The tipping assembly of claim 37, wherein at least one of the attachment member and cover portion are configured such that the attachment member and cover portion fit together with an interference fit.

47. The tipping assembly of claim 37, wherein the slot extends from a first edge to a second edge of the attachment member such that the cover portion may be inserted into the slot at either the first edge or second edge.

48. The tipping assembly of claim 37, wherein the attachment member is manually rotatable.

49. The tipping assembly of claim 37, wherein the attachment member comprises a plurality of passages therethrough, the attachment member comprising a row of passages.

50. The tipping assembly of claim 49, wherein the attachment member comprises a further row of passages arranged alongside the row of passages.

51. The tipping assembly of claim 37, wherein the cover portion comprises a plurality of mesh sections arranged in a row, and wherein the cover portion further comprises a plurality of openings configured to permit the transfer of insects from the first vials to the second vials respectively, the plurality of openings being arranged in a row alongside the row of mesh sections.

52. The tipping assembly of claim 51, wherein the cover portion comprises a further row of mesh sections, the further row of mesh sections being arranged alongside the row of openings in the cover portion such that the row of openings is disposed between the row of mesh sections and the further row of mesh sections.

53. The tipping assembly of claim 37, wherein the tipping assembly further comprises a rack for supporting ends of the attachment member.

54. Use of the tipping assembly of claim 37 in performing a negative geotaxis assay on the insects.

55. A method of transferring insects from one or more first vials to one or more second vials, the method comprising:
attaching one or more second vials to a second side of an attachment member to which one or more first vials are attached to a first side of the attachment member;
restricting one or more passages through the attachment member with a cover portion slidably received in a slot in the attachment member;
slidably retracting the cover portion from the slot in the attachment member;
turning the attachment member;
transferring insects from the one or more first vials to the one or more second vials respectively through the respective one or more passages in the attachment member; and
slidably inserting the cover portion into the slot in the attachment member to restrict the one or more passages through the attachment member.

56. The method of claim 55, wherein the method further comprises:
performing a negative geotaxis assay on the insects in the one or more second vials.
